(19) United States
(12) Patent Application Publication
(10) Pub. No.: US 2002/0095804 A1
(43) Pub. Date: Jul. 25, 2002

(54) Sheet material cutting device with safety guard

(76) Inventor: Jay E. Coplan, Carlsbad, CA (US)

Correspondence Address: MURPHEY & MURPHEY, A.PC., Pacific Center One, Suite 260, 701 Palomar Airport Road, Carlsbad, CA, 92009-1027, US

(21) Appl. No.: 09/769,673

(22) Filed: Jan. 25, 2001

(51) Int. Cl. B43L 7/00

(52) U.S. Cl. 33/484; 33/492

(57) ABSTRACT

A novel sheet material cutting device comprising an elongated planar base plate including a bottom base plate surface adapted to lie on the top surface of a flat sheet of cuttable material, a top base plate surface overlying the bottom surface and spaced-apart therefrom, at least one elongated straight cutting edge between the bottom surface and the top surface and parallel to the main axis of the base plate for contact with a cutting blade during cutting of sheet material lying under the bottom base plate surface, and a trailer edge spaced-apart from the cutting edge, and a guard wall extending upward from the base plate top surface, between the cutting edge and the trailer edge and parallel to the main axis of the base plate, the wall curved toward the trailer edge to provide an ever-expanding space between the cutting edge and the guard wall as a function of height above the base plate top surface.

### BACKGROUND OF THE INVENTION

1. Field of the Invention

This invention pertains to the field of tools and supplies for professional sign makers. More particularly, the invention pertains to a novel sheet material cutting device or safety ruler for making accurate cuts in paper and plastic sheet materials that contains a safety guard to prevent harm to the user.

2. Description of the Prior Art

“The signs of the times” is a famous line, Matthew 16:3. It portended the field of signage that now appears to rule our society. Signs are everywhere. They advertise—“FOR SALE”, they prohibit—“NO WALKING ON GRASS”, they seek—“A DOG IS LOST”, they caution—“WET PAINT”, and on and on. There are a lot of signs. What about the people who make the signs? Is it an enjoyable profession? Does it require skill to make the signs? Is any part of the business dangerous?

Those who make signs would be the first to state that a sign is only as good as it's outline. Cutting posters and other sign media is a difficult task because, in addition to carefully and accurately laying out the written, printed, painted and/or stenciled material, the overall poster or sign must be accurately cut or the sign will appear lopsided and not draw the attention it is designed to draw. Cutting the sign material, such as ⅛th inch thick poster board or ⅛th inch thick plastic, is difficult without the proper instruments. Even with some instruments now used and historically used, cutting accurately without cutting one's fingers is very difficult.

Initially, one would think that just drawing a line and cutting along the line with a razor blade or other sharp knife-type instrument would be an easy chore. However, much pressure must be brought to bear on the knife to drive the cutting blade completely through the poster board. When this much pressure is brought against the knife, the blade often bends and/or wobbles, causing the cut to be wavy. Especially when using a flat straight edge, one finds that by holding the straight edge with one hand and bringing the knife blade along the edge with the other hand, where the hands are spaced-apart and operated by different sets of muscles, often results in slipping of the knife and badly cutting the fingers or palm of the first hand holding the straight edge.

The prior art has tried to remedy this problem by placing an upstanding narrow or thin guard wall somewhere on the upper surface of the straight edge and using this wall, or “guard” as it is often called, as either the hand holding device or a protective device while the other hand operates the knife. This has not proved successful. To allow the wall to be a guard, one needs an uncomfortably wide straight edge that is clumsy to use. If the guard is set off-center and close to the cutting edge, the fingers wrapped about the cutting knife bump or ride against the guard resulting in either lacerated fingers or a wobbled knife blade that makes an uneven cut, especially when the hand holding the knife is rolled slightly outward to avoid contact with the guard. To place the guard at an angle adjacent the cutting edge requires the guard to be made to a very low profile resulting in the possibility that the blade will jump over the guard and lacerate the fingers of the holding-down hand. Finally, any wobble in the hand holding the cutting knife results in either a wavy cut in the poster board or driving the knife blade against the edge of the straight edge resulting (when the straight edge is aluminum) in cut-outs or dings in the aluminum that will appear in every cut thereafter, or will catch the blade each time it is drawn past the ding and interfere with an orderly cut in the poster board. Where the straight edge is steel, wobbling of the knife blade may result in damage to the blade.

Even other problems arise in the situation where a measuring scale is incorporated in the straight edge. The scale should be placed close to the cutting edge to prevent parallax from creating errors in measurement. However, when it is positioned close to the cutting edge it often takes the brunt of the cutting blade that slips over the cutting edge. Once a measuring scale is damaged, it is often hard to accurately repair. When the scale is moved away from the cutting edge, the user must then gauge the intersection of the measuring units on the poster board and inaccuracies often result. Even further, almost all cutting of signage is accomplished on work tables that have smooth, planar surfaces on which to lay the sheet material. In many instances, an overworked table results in unwanted grooves cut in the table surface. To avoid these grooves, one often moves the sheet material toward the middle of the table where cutting has been sparse and where there are no grooves. This requires the user to lean far over the table and place the cutting device away from his or her body. In this position, use of prior art cutting devices become even more unstable resulting in slipping of the knife and cutting of the fingers and hand.

### SUMMARY OF THE INVENTION

This invention is a novel, portable sheet material (signage) cutting device that includes an elongated planar base plate with a bottom base plate surface adapted to lie on the top surface of a flat sheet of cuttable material, a top base plate surface overlying the bottom surface and spaced-apart therefrom, at least one elongated straight cutting edge located between the bottom surface and the top surface and parallel to the main axis of the base plate for contact with a separate cutting blade during cutting of the sheet material lying under the bottom base plate surface, a trailer edge spaced-apart from the cutting edge, and a guard wall extending upward from the base plate top surface, between the cutting edge and the trailer edge and parallel to the main axis of the base plate, the wall curved toward the trailer edge to provide a protective cove for the hand and fingers holding the device in place on the sheet material and an ever-expanding space between the cutting edge and the guard wall as a function of height above the base plate top surface to allow the cutting hand free movement along the cutting edge.

The device is preferably extruded from aluminum to provide a dimensionally stable unit that is light-weight yet strong. One feature is the imposition of a steel cutting edge in the base plate that withstands the action of the passing cutting blade without creating dings and dents that occasion the use of aluminum as the cutting edge. Another feature is the combination of a flexible undermat that eliminates the need for a smooth surface on which to cut the sheet material. The most important feature, however, in the device is the curved guard wall that extends above the elongated base plate and protects the fingers and hands of the user against unwanted cutting and laceration from slippage of the knife blade during cutting of thick sheet material.

Accordingly, the main object of this invention is a portable sheet material (signage) cutting device that is extremely safe to use due to its unique curved guard wall that not only protects the user's hands from unwanted cuts due to loss of control of the knife when making cuts in thick or otherwise hard to cut material, but, because of its design, brings the user's hands closer together during the cutting operation thereby providing more stability to the use of the device. Other objects of the invention include a device for cutting signage without the need of a smooth topped work table, a device that is more accurate because of the placement of a measuring tape in the device and a pointer for use therewith that reduces parallax to a minimum, a device that has a hard metal straight edge to prevent damage due to catching the knife blade on the straight edge, and a device that is simple to manufacture, due to its extruded nature, and thus lower cost than other devices on the market.

These and other objects of the invention will become more clear when one reads the following specification, taken together with the drawings that are attached hereto. The scope of protection sought by the inventor may be gleaned from a fair reading of the claims that conclude this specification.

### DESCRIPTION OF THE DRAWINGS

FIG. 1 is a perspective view of the preferred embodiment of this invention showing a person using it to cut sheet material;

FIG. 2 is an elevational, cross-sectional view of one of the preferred embodiments of the invention showing the basic features and how the marker slides over the measuring tape;

FIG. 3 is a bottom plan view of a short length of one of the preferred embodiments of the invention showing the lands and how they are positioned under the bottom surface of the device;

FIG. 4 is a similar elevational, cross-sectional view of one of the preferred embodiments of the invention showing the formation of the protective cove, on one side of the curved guard wall, and the large, ever-increasing area for interposition of the hand holding the cutting knife on the other side of the curved guard wall;

FIG. 5 is an elevational, cross-sectional view of another of the preferred embodiments of the invention taken along lines 5-5 in FIG. 1;

FIG. 6 is a front elevational view of the marker tab useful in this invention;

FIG. 7 is a bottom plan view of the embodiment shown in FIG. 5 showing the outline of the base plate in dotted outline; and,

FIG. 8 is a perspective view of the preferred embodiment of the invention showing how the tape measure can be partially slid out of the retaining channel and used to make measurements that are longer than the device.

### DESCRIPTION OF THE PREFERRED EMBODIMENT

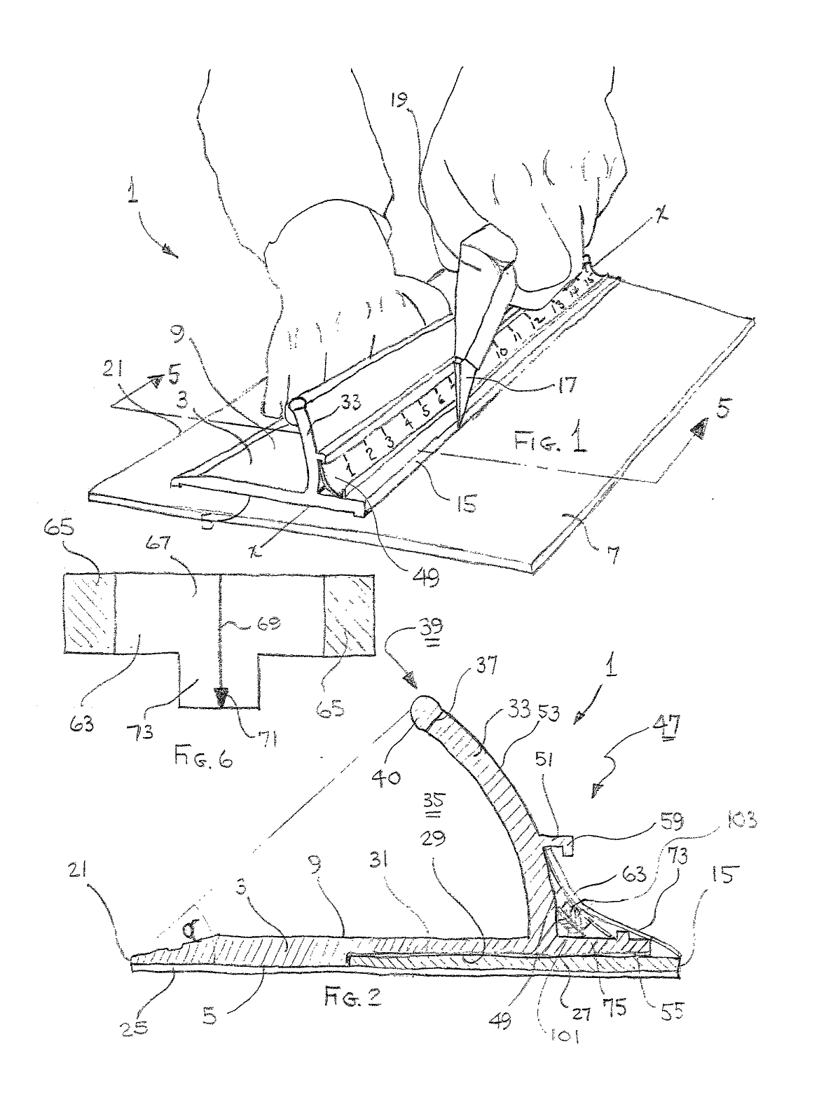

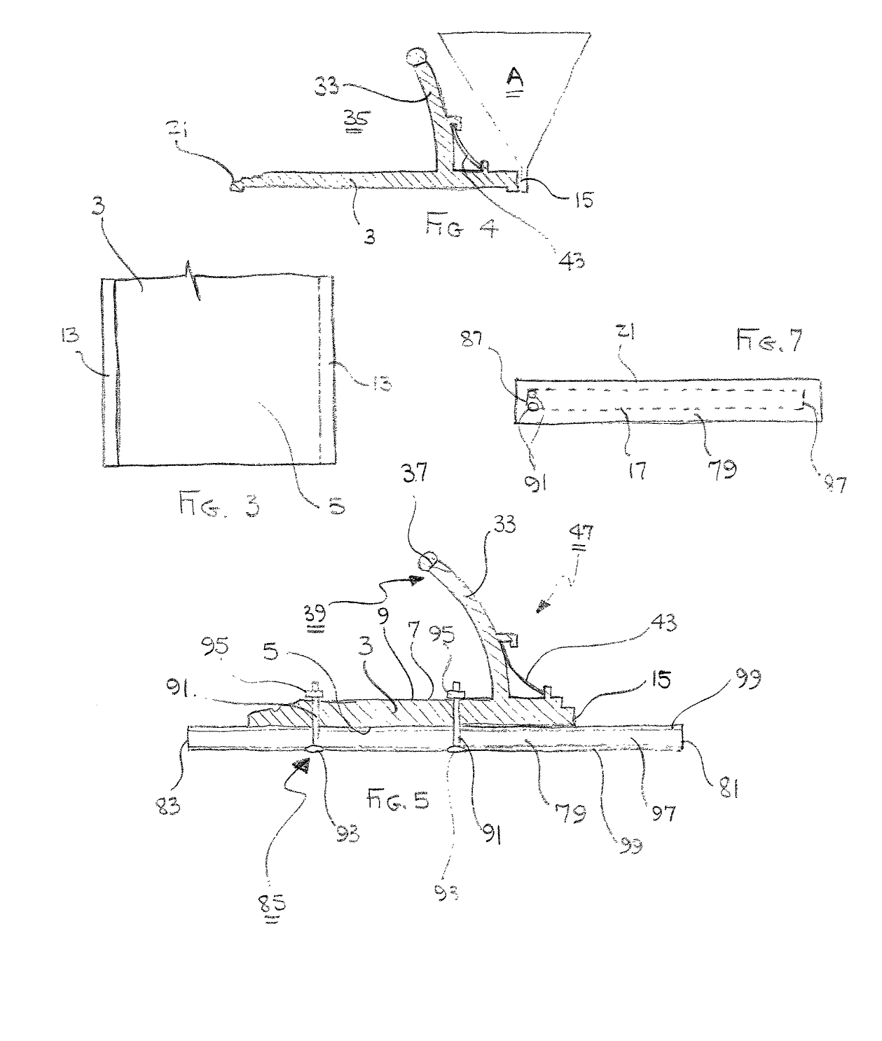

Turning now to the drawings wherein elements are identified by numbers and like elements are identified by like numbers throughout the 7 figures, the invention is depicted in FIGS. 1, 2 and 3 as a novel sheet material cutting device 1 comprising an elongated planar base plate 3, preferably rectangular in outline, defined by bottom base plate surface 5, also preferably planar, for lying over the top of sheet material 7 to be cut, and a top base plate surface 9 overlying bottom surface 5 and spaced-apart therefrom. As shown in FIG. 3, a pair of narrow, spaced-apart, contact lands 13, arranged parallel to each other and parallel to said cutting edge, extending downward from said bottom base plate surface for contact with the top surface of the flat sheet of cuttable material. The use of contact lands 13 is optional and bottom surface 5 can be used to contact sheet material 7 in the absence of said lands and lands 13 may be replaced with a layer of non-skid material as will be hereinafter more fully explained.

At least one elongated straight cutting edge 15 is located along one long edge of base plate 3, between bottom surface 5 and top surface 9, and preferably is arranged parallel to the main axis, x-x, of base plate 3 for contact with a cutting blade 17 extending from a knife 19 held by the hand of the user during cutting of sheet material 7 lying under bottom base plate surface 5. Cutting edge 15 is preferably made flat and arranged perpendicular to bottom surface 5. A opposite trailer edge 21 is formed on base plate 3 and preferably located parallel to axis x-x, and spaced-apart from, and preferably parallel to, cutting edge 15.

As shown in FIG. 2, a layer 25 of non-skid material is placed over base plate bottom surface 5 for use in preventing device 1 from slipping and sliding on sheet material 7 during use. This slipping and sliding often occurs in the absence of a layer of non-skid material because device 1 is used under rather strong downward pressure from the user's arms, first, to hold base plate 3 with one hand in the desired exact location on sheet material 7 and, secondly, to draw the knife with the other hand in a controlled motion along cutting edge 15. An example of layer 25, of non-slip material useful in this invention, is a rubber-coated, non-slip nylon fabric made by Eastex Co., of Hingham, Mass. Layer 25 is preferably attached to base plate bottom surface using an industrial glue.

Also as shown in FIG. 2, it is preferred that cutting edge 15 be made of a wide strip 27 of metal harder than aluminum such as tool steel and the like. When using aluminum for base plate 3, strip 27 can easily be placed in a wide inset 29, formed in plate 3, and attached to base plate 3 by a layer of adhesive 31, as shown, or other such fastening means. When using contact lands 13, it is preferred that one of them be arranged to lie near to or adjacent cutting edge 15.

As shown in FIGS. 1, 2, 4 and 5, a guard wall 33 extends upward from base plate top surface 9, between cutting edge 15 and trailer edge 21, preferably closer to cutting edge 15. It is preferred that guard wall 33 begins its upward direction orthogonal to the plane of base plate top surface 9 and is also arranged parallel to main axis x-x of base plate 3. Also as shown in FIG. 2, guard wall 33 is arranged to then curve toward trailer edge 21, as it rises, to provide a protective cove 35, in which the hand holding down base plate 3 is located, and an ever-expanding open space, shown as triangle A, (FIG. 4) located between guard wall 33 and cutting edge 15 as a function of rising height above base plate top surface 9.

As shown in FIG. 5, guard wall 33 is preferably terminated by a security edge 37, arranged parallel to cutting edge 15 and has a safety means 39 formed therealong for inhibiting passage of cutting blade 17 across guard wall 33 and into the hand or wrist of the user holding base plate 3 to sheet material 7. One form of safety means 39 is shown in FIG. 2 as a bead 40 mounted along edge 37 to intersect cutting blade 17 should it stray from cutting edge 15. It is preferred that guard wall 33 is of uniform thickness throughout and terminates at an angle “α” of less than 45° from plane x-x of base plate 3. This same shape of guard wall 33 may be achieved, as shown in FIG. 2, by forming it along a path formed by a series of short straight chords 41, joined in end-to-end fashion. It is important in all cases that the initial upward direction of guard wall 33 be orthogonal to plane x-x of base plate 3 and it is further important that guard wall 33 be formed in a non-rectilinear manner and ultimately directed toward trailer edge 21 to provide cove 35 on the trailer edge side of guard wall 33 to shield the hand of the user from the dangers of cutting blade 17, and, on the other side of guard wall 33, an ever-expanding space A between cutting edge 15 and guard wall 33 as a function of height above base plate top surface 9. A flat or flat-slanted guard wall has been found not to provide the size of cove 35 sufficient to satisfy the room requirements for the fingers of the hand holding down base plate 3. The fingers become pinched and this is uncomfortable for the holder. To relieve this discomfort, the user will move his or her hands out of cove 35 toward trailer edge 21 thus spreading the hands even further apart and creating more instability in the cutting device. Once the hands are moved further apart, the device becomes unstable and the sheet material or other material being cut by blade 17 begins to bunch up under bottom surface 5. It is exceedingly important to have guard wall 33 formed in a curved fashion to allow the hand holding device 1 to be located as close to the cutting edge as possible yet shielded from cutting blade 17 during the cutting process. With this unique arrangement of parts, the hand holding knife 19 is positioned directly over cutting edge 15 thereby allowing fall hand pressure to be brought to bear on cutting blade 17 for an efficient and trouble-free cutting process. While cutting blade 17 is passing along cutting edge 15, in making the cut of the sheet material lying underneath bottom surface 5, a certain amount of force must also be applied sideways against cutting edge 15 in order to maintain contact between blade 17 and straight cutting edge 15. This makes for a straight line in the cut. It is preferred that base plate 3 and guard wall 33 be formed of aluminum in one monolithic extrusion. A base plate and guard wall thickness of 0.14 inch has been found to be extremely useful, providing the right mix of strength and light weight.

As shown in FIGS. 1, 2, 4 and 5, a measuring scale 43 is mounted on device 1 and aligned parallel and adjacent to cutting edge 15. To reduce cost of manufacturing, the inventor has discovered that metal measuring tapes are less expensive than the process of forming the lines and numbers in base plate 3 or cutting edge 15. Accordingly, in the manufacture of this invention, great cost savings are realized by providing a means 47 for mounting a length of metal measuring tape 49 on device 1, parallel to and observable from cutting edge 15. As shown in FIG. 2, one form of mounting means 47 is to form a first ledge 51 extending outward from the outer surface 53 of guard wall 33 toward cutting edge 15 and preferably parallel to the plane of base plate bottom surface 5. A second ledge 55 is formed on base plate top surface 9 extending upward from base plate top surface 9. An offset or leg 59 is formed along the outer edge of first ledge 51, directed toward the other ledge, to retain measuring tape 49 between the ledges as shown. In addition to means 47 mounting a length of metal measuring tape 49 on device 1, it also acts as a safety device to guard against finger and hand cuts. If one notes the proximity of cutting blade 17 to the hand holding the invention down on a surface to be cut by that blade, one can easily see that both first ledge 51 and second ledge 55 jut into the air above top surface 9 and pose a block to travel of blade 17 in a transverse path from cutting edge 15 to the hand holding device 1 down on the surface. This is an additional safety feature of this invention.

As shown in FIGS. 2 and 8, measuring tape 49 is held in channel 75 by a pair of small strips 101 and 103, respectively, of interfastenable yet releasable strips of material such as Velcro®, one strip 101 attached to guard wall 33 and the other strip 103 attached to the back side of measuring tape 49 and the strips pressed together to detachably retain measuring tape 49 in channel 75. Detaching Velcro® strip 101 from strip 103 allows the user to slide the measuring tape partially outward from channel 75 to be able to measure distances longer than the device itself as shown in FIG. 8. This added feature is only possible by inserting the measuring tape in channel 75 in the channel and holding it in channel 75 by strips 101 and 103.

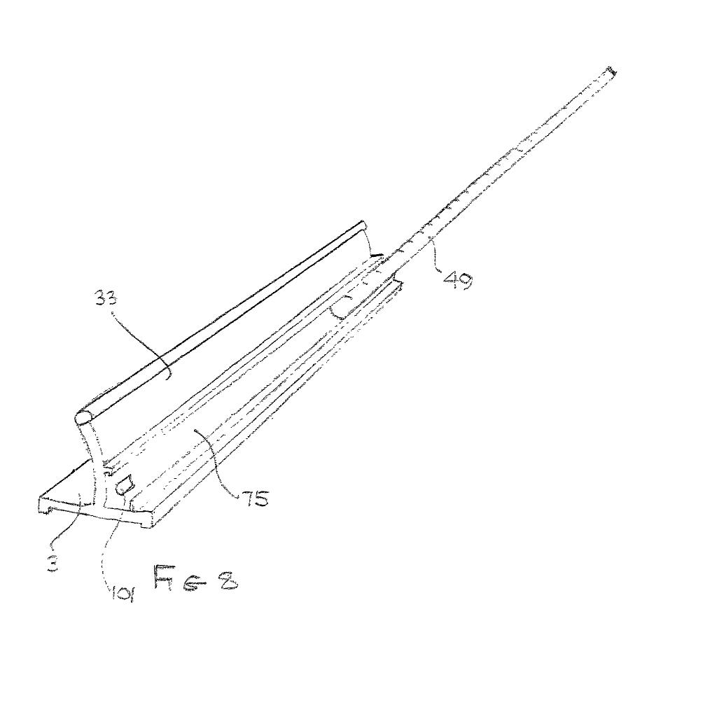

As shown in FIGS. 2 and 6, a transparent marker 63 is slidingly mounted in front of measuring tape 49, between first and second ledges 51 and 55 respectively, and adapted to slide along on top of measuring tape 49. One embodiment of marker 63 is shown in FIG. 6 and comprises a T-shaped piece of clear plastic sheeting having opposed arms 65 extending outwardly from a center body 67 that is bisected by a line 69 having an arrow head 71 printed or otherwise placed on a tab 73 extending outward from center body 67 to touch the top of cutting edge 15. Arms 65 are arranged to slide in channel 75, formed between ledges 51 and 55, along and over top of measuring tape 49, while tab 73, carrying arrow head 71, extends toward cutting edge 15 so that line 69 accurately translates a position on measuring tape 49 to a point on cutting edge 15.

As shown in FIG. 5, another embodiment of the invention shows the same elements in their same orientation, including elongated planar base plate 3, bottom base plate surface 5, top base plate surface 9, cutting edge 17, and guard wall 33. In this embodiment, however, a flexible undermat 79 is provided, made wider than elongated planar base plate 3, and defined by spaced-apart, elongated side edges 81 and 83, respectively, wherein edge 81 extends outward from under cutting edge 15 and beyond. Undermat 79 is provided in a thickness such as ¼ inch wherein downward pressure of cutting blade 17 would not normally pass completely through it. Means 85 are provided for temporarily attaching undermat 79 to one or both terminal ends 87 of base plate 3. One form of means 85 is shown in FIGS. 5 and 7 as a pair of spaced-apart bolts 91, passing upward through apertures formed in base plate 3 and undermat 79, that are held fast to base plate 3 at one end by a bolt head 93, countersunk into undermat 79 and at the other end by a nut 95 threadably received thereover. Undermat 79 is shown in FIG. 13 to be preferably formed as a laminate containing a center sheet 97 of low density polyethylene plastic glued between upper and lower layers 99 of non-slip rubber-coated nylon fabric. In using this second embodiment, one may lay device 1 on any flat surface, such as an office desk or dining room table and arrange the sheet material under base plate bottom surface 5 and above undermat 79. The cutting takes place above undermat 79 so that whatever surface device 1 is set upon will not be damaged by passage of cutting blade 17 along cutting edge 15. Undermat 79 may be penetrated with a plurality of apertures for receipt therein of bolts 91. As upper layer 99 becomes damaged with cuts from knife blade 17, undermat 79 may be moved to one side or the other and bolts 91 repositioned in other apertures to provide a fresh surface to knife balde 17.

While the invention has been described with reference to a particular embodiment thereof, those skilled in the art will be able to make various modifications to the described embodiment of the invention without departing from the true spirit and scope thereof. It is intended that all combinations of elements and steps which perform substantially the same function in substantially the same way to achieve substantially the same result are within the scope of this invention.

What is claimed is:

1. A novel sheet material cutting device comprising:
a) an elongated planar base plate including:
i) a bottom base plate surface adapted to lie on the top surface of a flat sheet of cuttable material;
ii) a top base plate surface overlying said bottom surface and spaced-apart therefrom;
iii) at least one elongated straight cutting edge between said bottom surface and said top surface and parallel to the main axis of said base plate for contact with a cutting blade during cutting of sheet material lying under said bottom base plate surface; and,
iv) a trailer edge spaced-apart from said cutting edge; and,
b) a guard wall extending upward from said base plate top surface, between said cutting edge and said trailer edge and parallel to the main axis of said base plate, said wall curved toward said trailer edge to provide an ever-expanding space between said cutting edge and said guard wall as a function of height above said base plate top surface.

2. The novel sheet material cutting device of claim 1 wherein said guard wall is terminated by a security edge, parallel to said cutting edge, said security edge having safety means formed therealong for inhibiting passage of the cutting blade thereacross.

3. The novel sheet material cutting device of claim 1 wherein the initial upward direction of said guard wall is orthogonal to the plane of said base plate.

4. The novel sheet material cutting device of claim 1 wherein said guard wall is of uniform thickness throughout and said curved guard wall terminates at and angle less than 45° from the plane of said base plate.

5. The novel sheet material cutting device of claim 1 further including a pair of narrow, spaced-apart, contact lands, arranged parallel to each other and parallel to said cutting edge, extending downward from said bottom base plate surface for contact with the top surface of the flat sheet of cuttable material.

6. The novel sheet material cutting device of claim 5 wherein one said contact land lies adjacent said cutting edge.

7. The novel sheet material cutting device of claim 1 further including a measuring scale aligned parallel to said cutting edge.

8. The novel sheet material cutting device of claim 1 further including means for mounting a measuring tape parallel to and observable from said cutting edge.

9. The novel sheet material cutting device of claim 8 wherein said means for mounting a measuring tape comprise:
a) a first ledge extending outward from said guard wall toward said cutting edge;
b) a second ledge extending upward from said top base plate surface; and,
c) an offset formed on one of said ledges, directed toward said other of said ledges, to retain a measuring tape between said ledges.

10. The novel sheet material cutting device of claim 9 further including a marker mounted between said first and second ledges and adapted to slide along said measuring tape, and further including a pointer extending across said tape to said cutting edge to accurately relate points on said measuring tape to said cutting edge.

11. The novel sheet material cutting device of claim 1 wherein said base plate is aluminum and said device further includes a strip of metal, harder than aluminum, forming said cutting edge.

12. The novel sheet material cutting device of claim 1 further including a layer of non-skid material covering said bottom base plate surface for contact with the sheet material to be cut.

13. A novel sheet material cutting device comprising:
a) an elongated planar base plate of terminal length including:
i) a bottom base plate surface adapted to lie above a flat sheet of cuttable material;
ii) a top base plate surface overlying said bottom surface and spaced-apart therefrom;
iii) at least one elongated straight cutting edge arranged between said bottom surface and said top surface and parallel to the main axis of said base plate for contact with an independent cutting blade during cutting of sheet material lying below said bottom base plate surface; and,
iv) a trailer edge, opposite said cutting edge, and spaced-apart therefrom;
b) a guard wall extending upward from said base plate top surface, between said cutting edge and said trailer edge and parallel to the main axis of said base plate, said wall formed in a non-rectilinear manner and ultimately directed toward said trailer edge to provide, on one side of said guard wall, a cove therebeneath and, on the other side of said guard wall, an ever-expanding space between said cutting edge and said guard wall as a function of height above said base plate top surface;
c) a flexible undermat, wider than said elongated planar base plate, and defined by spaced-apart, elongated side edges, one of which extends outward from under said cutting edge, said undermat being of a thickness wherein downward pressure of a cutting blade would not normally pass completely through said mat; and,
d) means for temporarily attaching said flexible undermat to one terminal end of said base plate.

14. The novel sheet material cutting device of claim 13 wherein said flexible under mat comprises:
a) a center layer of flexible, low-density polymeric material; and,
b) top and bottom layers of flexible, non-slip polymeric material;
c) said center layer and said top and bottom layers arranged in a single, three-layer laminate.

15. The novel sheet material cutting device of claim 13 wherein said means for temporarily attaching said flexible undermat to one terminal end of said base plate includes at least one bolt and nut combination fit through an aperture formed in said base plate and said undermat.

16. The novel sheet material cutting device of claim 13 wherein said base plate and said guard wall are formed of one monolithic extrusion of aluminum.

17. The novel sheet material cutting device of claim 13 wherein said guard wall is formed along a radius to form a curve.

18. The novel sheet material cutting device of claim 13 wherein said guard wall is formed along a series of short straight chords, joined in end-to-end fashion, to form a short curve-like configuration.

19. The novel sheet material cutting device of claim 13 wherein said base plate is aluminum and said device further includes a strip of metal, harder than aluminum, forming said cutting.

20. The novel sheet material cutting device of claim 13 farther including means for mounting a measuring tape in said device wherein said means comprise:
a) a first ledge extending outward from said guard wall toward said cutting edge;
b) a second ledge extending upward from said top base plate surface to form a channel with said first ledge;
c) an offset formed on one of said ledges, directed toward said other of said ledges, to retain a measuring tape in sliding arrangement between said ledges;
d) a marker mounted between said first and second ledges and adapted to slide along said measuring tape, and farther including a pointer extending across said tape to said cutting edge to accurately relate points on said measuring tape to said cutting edge; and,
e) means for detachably retaining said measuring tape in said channel.
